(19) United States
(12) Patent Application Publication
(10) Pub. No.: US 2016/0157471 A1
(43) Pub. Date: Jun. 9, 2016

(54) FISHING LURE HAVING A DYING MINNOW ACTION

(71) Applicant: Normark Innovations, Inc., Minnetonka, MN (US)

(72) Inventor: Harri Leppala, Vaaksy (FI)

(21) Appl. No.: 14/959,090

(22) Filed: Dec. 4, 2015

Related U.S. Application Data
(60) Provisional application No. 62/087,329, filed on Dec. 4, 2014.

(51) Int. Cl. A01K 85/16

(52) U.S. Cl. CPC A01K 85/16

(57) ABSTRACT

A fishing lure that includes a hull and a diving plane on a head portion of the hull is provided. The hull can have a pair of side walls oriented on opposite sides, a top wall, and a bottom wall. The hull can define a cavity therein. The side walls can be sufficient to allow for contraction and expansion at different water temperatures during fishing. A method of fishing is also generally provided using such a fishing lure.

### PRIORITY INFORMATION

The present application claims priority to U.S. Provisional Patent Application Ser. No. 62/087,329 titled “Fishing Lure Having a Dying Minnow Action” of Leppala filed on Dec. 4, 2014, the disclosure of which is incorporated by reference herein.

### BACKGROUND

Sport fishing is enjoyed around the world. From fresh water to salt water, a wide variety of fish species exist. Fishermen employ a variety of equipment and tackle depending upon the water being fished, the time of day, the species of fish sought, personal choice, and many other factors. A fishing lure, sometimes referred to as an artificial lure, is frequently a part of such equipment and tackle.

Fishing lures are typically designed and decorated with the goal of replicating or mimicking the movement and appearance of a food source for the particular fish being sought. For example, such lure may take on the shape of a minnow, tadpole, frog, mouse, insect, salamander, another fish, or such other food source. The fisherman's hope is that by having a lure closely resembling or acting like a source of food, fish will be enticed into biting the lure.

In an effort to make the lure aesthetically realistic, a designer can use materials pigmented with the desired colors. For example, colored plastics or rubber may be used. In addition, a designer can paint or stain the external surface of the lure to achieve the desired color and marking characteristics. Decorative features such as scales, eyes, and fins may be painted onto the surface or otherwise added to the lure.

Lures can also be designed with features that make the lure realistic in a functional manner. Fins, diving planes, spinners, rattles and the like may be added in order to make the lure move and sound like a food source. Some lures may be specifically designed to operate on the water surface while others may function only when below. Generally speaking, the lure's overall shape, the weight of the lure, the design of any lip on the lure, and the location of the point of attachment to the fishing line can affect the swim path of the lure during retrieval.

Typically, deep diving lures have diving planes made out of either a plastic material or a metal material. However, both types of materials present certain disadvantages in their respective use. For example, a diving plane made from a plastic material relies almost exclusively on the performance of the diving plane to bring the lure to deeper depths. Alternatively, a metal diving plane can rely on both the weight of the diving plane and the performance of the diving plane to bring the lure to deeper depths.

As such, a need exists for a fishing lure that is capable of accurately mimicking a dying minnow over a wide range of water temperatures. Typical suspending or slow sinking fishing lures used in cold water will tend to sink faster in warm water because warm water has a lower density. Ideally, it is desired for a lure to have the same action whether the water is cold or warm.

### SUMMARY

Objects and advantages of the invention will be set forth in part in the following description, or may be obvious from the description, or may be learned through practice of the invention.

A fishing lure is generally provided. In one embodiment, the fishing lure includes a hull and a diving plane on a head portion of the hull. The hull having a pair of side walls oriented on opposite sides, a top wall, and a bottom wall. The hull defines a cavity therein. The side walls are sufficient to allow for contraction and expansion at different water temperatures during fishing.

A method of fishing is also generally provided using such a fishing lure. In one embodiment, the method includes casting the fishing lure into a body of water, where the fishing lure is attached to a fishing line; allowing the fishing lure to sink within a body of water; jerking the fishing line such that the fishing lure kicks within the body of water; and thereafter, allowing the fishing lure to sink within a body of water.

Other features and aspects of the present invention are discussed in greater detail below.

### BRIEF DESCRIPTION OF THE DRAWINGS

A full and enabling disclosure of the present invention, including the best mode thereof to one skilled in the art, is set forth more particularly in the remainder of the specification, which includes reference to the accompanying figures, in which:

FIG. 1 shows a side view of an exemplary fishing lure according to one embodiment of the present invention;

FIG. 2 shows a top view of the exemplary fishing lure of FIG. 1;

FIG. 3 shows a bottom view of the exemplary fishing lure of FIG. 1;

FIG. 4 shows a cut-away view from the rear perspective of the exemplary fishing lure of FIG. 1; and

FIG. 5 shows a front view of the exemplary fishing lure of FIG. 1.

Repeat use of reference characters in the present specification and drawings is intended to represent the same or analogous features or elements of the present invention.

### DETAILED DESCRIPTION

Reference now will be made to the embodiments of the invention, one or more examples of which are set forth below. Each example is provided by way of an explanation of the invention, not as a limitation of the invention. In fact, it will be apparent to those skilled in the art that various modifications and variations can be made in the invention without departing from the scope or spirit of the invention. For instance, features illustrated or described as one embodiment can be used on another embodiment to yield still a further embodiment. Thus, it is intended that the present invention cover such modifications and variations as come within the scope of the appended claims and their equivalents. It is to be understood by one of ordinary skill in the art that the present discussion is a description of exemplary embodiments only, and is not intended as limiting the broader aspects of the present invention, which broader aspects are embodied exemplary constructions.

A fishing lure is generally provided that is configured to closely mimic the movements of a dying minnow when fished/retrieved in a certain manner. Specifically, the fishing lure can be fished/retrieved to have an action that appears in the water as a repeating kick followed by a slow flickering fade. This dying minnow action is believed to entice a fish to bite the fishing lure.

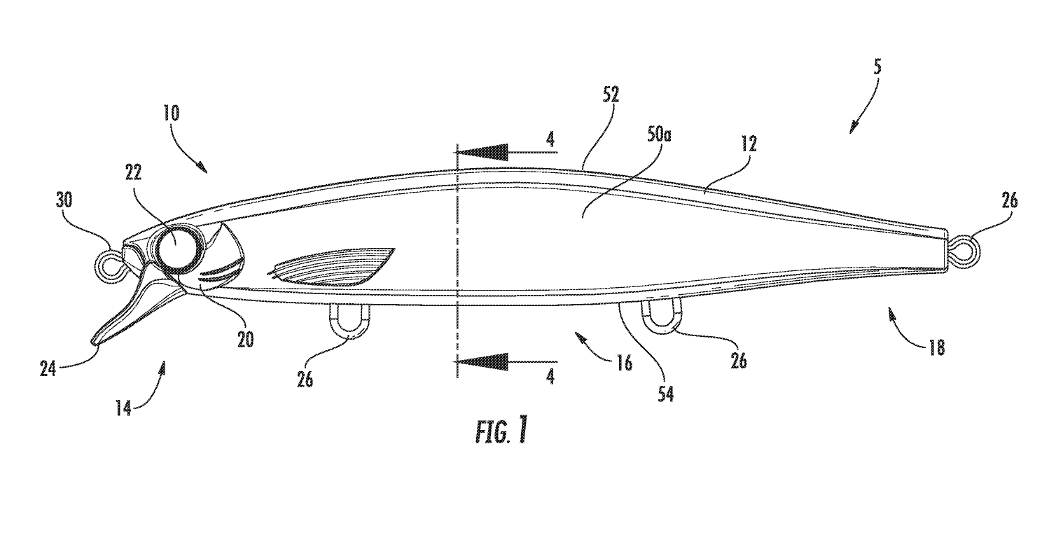

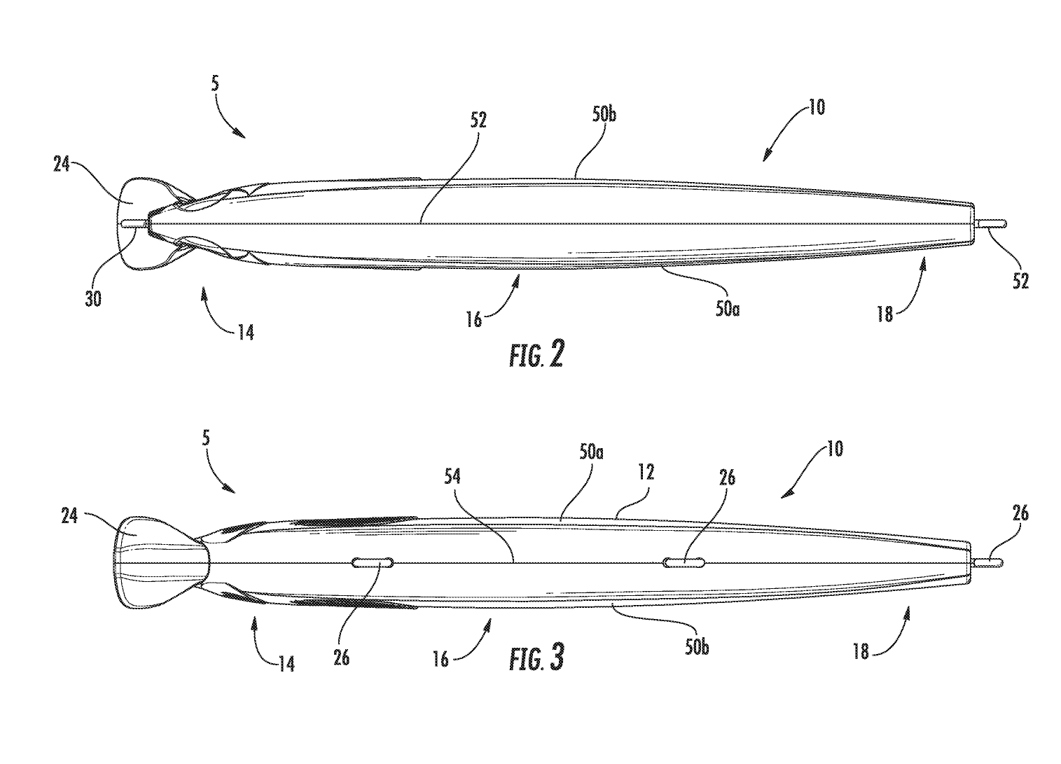

Referring to FIG. 1, an exemplary embodiment of a fishing lure 5 is shown including a lure body 10 according to the present invention is illustrated. The lure body 10 includes a hull 12 configured in the overall shape of the lure. It should be appreciated that the size and shape of the hull 12 may be configured in various combinations depending on the particular type of lure body 10 desired. In the illustrated embodiment, hull 12 has a generally streamlined configuration and includes a head section 14, a middle section 16, and a tail section 18.

The hull 12 is generally defined by a pair of side lure walls 50a, 50b that are oriented on opposite sides of the lure body 10, a top wall 52 and a bottom wall 54, and is generally formed from a polymeric material. In one embodiment, the hull is formed from an acrylonitrile butadiene styrene (ABS) polymer, which is a terpolymer made by polymerizing styrene and acrylonitrile in the presence of polybutadiene.

The side walls 50a, 50b have a thickness that is sufficient to allow for a relatively stiff hull 12 while being thin enough to allow for contraction and expansion at different water temperatures during fishing. That is, the side walls 50a, 50b are configured to expand or contract upon heating or cooling, respectively, of gas particles (e.g., air) present within the cavity 56 of the hull 12. During use, these expansion and contraction characteristics of the side walls 50a, 50b lead to the dying minnow action of the lure 5, as explained in greater detail below. By making the side walls thin enough to expand and increase the enclosed volume in warmer water, the action of the lure can be relatively consistent over a wide range of water temperatures.

In one embodiment, each side wall 50a, 50b can have a thickness of about 0.5 mm to about 1.0 mm, particularly when formed from an ABS polymer. In such an embodiment, the top wall 52 and the bottom wall 54 can have a thickness of about 1.0 mm to about 1.5 mm (e.g., about 1.2 mm to about 1.4 mm, such as about 1.3 mm).

The hull 12 also includes any number or combination of ornamental features intended to provide the lure body 10 with a more realistic and life-like appearance. For example, the hull 12 may be provided with scales, gills, fins, eyes, or other characteristics. Exemplary hull 12 includes ornamental features such as scales 20 and eye 22. A diving plane 24 is located near the head section 14 of hull 12. As the lure is being retrieved through the water, diving plane 24 drives the lure body 10 to a certain depth within the water. The depth to which the lure body 10 will travel is dependent upon variables such as the angle of the diving plane 24, the speed of the retrieve, the temperature of the water, etc.

For this exemplary embodiment of the invention, lure body 10 is equipped with three hook loops 26 for attachment of hooks (not shown). However, FIG. 1 is only an example of the number and positioning of loops 26 and hooks. One or any number of various types of hooks may be positioned on lure body 10 as desired. Also shown by way of example is line loop 30 for the attachment of fishing line to the lure body 10. Although shown on the head portion 14 of the hull 12, the line loop 30 may be positioned on the diving plane 24. Other mechanisms may be used in a variety of configurations and locations on lure 5 for attaching the line.

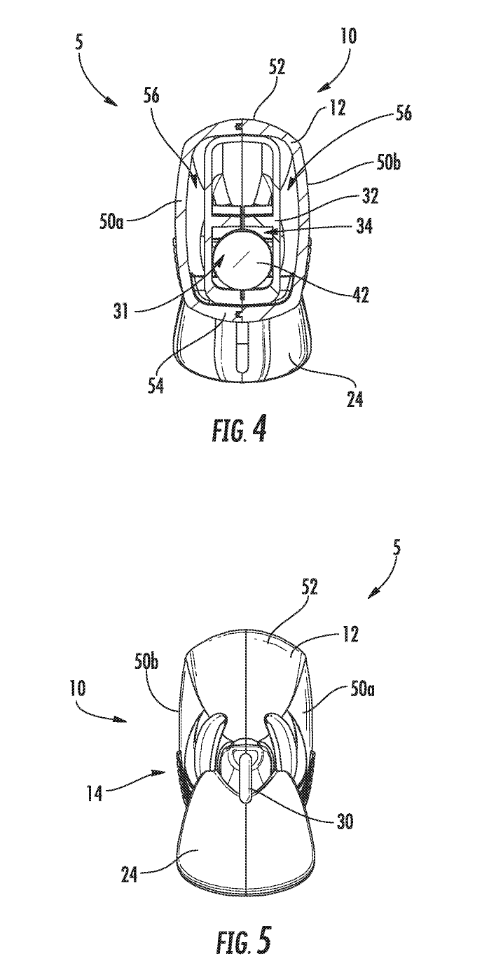

As best seen in FIG. 4, the configuration of the hull 12 allows for a cavity 56 in the open space between the first side wall 50a and the second side wall 50b. The fishing lure 10 includes a movable weight system 31 within the cavity 56, such as shown and described in U.S. Pat. No. 6,609,326 of Salonen, et al.; the disclosure of which is incorporated by reference herein. Referring now to FIG. 4, lure body 10 is constructed from hull 12 and a cartridge 32 that is inserted into or contained within hull 12. Cartridge 32 defines an interior channel 34 that is oriented longitudinally along the cartridge 32 of lure body 10. The interior channel 34 includes a single chamber defined in the direction moving from the head section 14 to the tail section 18 of body 10, although the interior channel 34 could be formed from a variety of configurations—including internals walls or other internal structures.

A plurality of weights 42 are positioned within interior channel 34 and configured for movement along the interior channel 34. As shown in the exemplary embodiment of the figures, the weights 42 are cylindrically shaped and can be made to roll or slide along interior channel 34 in the longitudinal direction (i.e., from the head section 14 to the tail section 18, and vice-versa) of cartridge 32 when lure body 10 is in use. Any number of weights 42 may used. Furthermore, a lure body 10 utilizing only one weight is within the scope of the present invention as set forth in the claims below.

During casting, the plurality of weights 42 generally remains in the cartridge 32 toward its tail section 18. As the lure body 10 lands and come to rest in the water, the lure body 10 remains in a vertical position in the water and the plurality of weights 42 therefore also remain towards the tail section 18. Again, in this position, the center of gravity of lure body 10 remains generally within tail section 18 of lure body 10.

After landing in the water, the angler begins to retrieve the lure body 10 by reeling in fishing line that is connected to the line loop 30 in the head section 14. As the lure body 10 is pulled forward at the point of connection (loop 30) with the fishing line (not shown), the diving plane 24 drags against the water and causes the lure body 10 to move from the vertical position to the horizontal position shown. As a result, the plurality of weights 42 are caused to slide or roll along interior channel 34 toward the head section 14.

As the plurality of weights 42 move toward the portion of the cartridge 32 of the head section 14, the overall center of gravity of lure body 10 is moved towards the head section 14 of lure body 10 to ensure proper operation and movement of the lure body 10 as it is retrieved through the water by the angler.

As the lure sinks in the body of water being fished, the water temperature generally decreases with an increase in the depth. These changes in the water temperature (i.e., lower temperature) causes the side walls 50a, 50b to contract.

This contraction causes the lure 5 to have a slow sinking action when no force is asserted onto the line loop. Then, the fishing line can be jerked to cause the lure 5 to “kick” followed by allowing the lure 5 to again slowly sink while remaining substantially horizontal (due to the weighting of the lure) and flickering side-to-side about the longitudinal axis of the lure (extending from the head section to the tail section). Repeating this kick/slow sink action allows the lure 5 to closely mimic the movements of a dying minnow when fished/retrieved.

These and other modifications and variations to the present invention may be practiced by those of ordinary skill in the art, without departing from the spirit and scope of the present invention, which is more particularly set forth in the appended claims. In addition, it should be understood the aspects of the various embodiments may be interchanged both in whole or in part. Furthermore, those of ordinary skill in the art will appreciate that the foregoing description is by way of example only, and is not intended to limit the invention so further described in the appended claims.

What is claimed:

1. A fishing lure comprising:
a hull comprising a pair of side walls oriented on opposite sides, a top wall, and a bottom wall, wherein the hull defines a cavity therein, and wherein the side walls sufficient to allow for contraction and expansion at different water temperatures during fishing;
a diving plane on a head portion of the hull.

2. The fishing lure of claim 1, further comprising:
a line loop on the head portion of the hull or on the diving plane.

3. The fishing lure as in claim 1, wherein the hull defines a cavity having a gas therein.

4. The fishing lure as in claim 3, wherein the gas is air.

5. The fishing lure as in claim 1, wherein the side walls have a thickness of about 0.5 mm to about 1.0 mm.

6. The fishing lure as in claim 1, wherein the top wall has a thickness of about 1.1 mm to about 1.5 mm.

7. The fishing lure as in claim 1, wherein the bottom wall has a thickness of about 1.1 mm to about 1.5 mm.

8. The fishing lure as in claim 1, further comprising:
a movable weight system within the cavity of the hull.

9. The fishing lure as in claim 1, wherein the hull comprises a polymeric material.

10. The fishing lure as in claim 1, wherein the hull comprises an acrylonitrile butadiene styrene polymer.

11. A method of fishing using the fishing lure of claim 1, the method comprising:
casting the fishing lure into a body of water, wherein the fishing lure is attached to a fishing line;
allowing the fishing lure to sink within a body of water;
jerking the fishing line such that the fishing lure kicks within the body of water; and thereafter
allowing the fishing lure to sink within a body of water.

12. The method as in claim 11, further comprising:
repeating the steps of jerking the fishing line such that the fishing lure kicks within the body of water; and thereafter allowing the fishing lure to sink within a body of water.

13. A method of fishing, comprising:
casting a fishing lure into a body of water, wherein the fishing lure is attached to a fishing line, and wherein the fishing lure comprises a hull having a pair of side walls oriented on opposite sides, a top wall, and a bottom wall, the hull defining a cavity therein, and wherein the side walls sufficient to allow for contraction and expansion at different water temperatures during fishing;
allowing the fishing lure to sink within a body of water;
jerking the fishing line such that the fishing lure kicks within the body of water; and thereafter
allowing the fishing lure to sink within a body of water.
